(19) United States
(12) Patent Application Publication
(10) Pub. No.: US 2023/0109302 A1
(43) Pub. Date: Apr. 6, 2023

(54) Nestable Covering Assembly

(71) Applicants: Santiago Acevedo, Renton, WA (US); Montrae Gooden, Renton, WA (US)

(72) Inventors: Santiago Acevedo, Renton, WA (US); Montrae Gooden, Renton, WA (US)

(21) Appl. No.: 17/494,954

(22) Filed: Oct. 6, 2021

(51) Int. Cl. B60J 7/14

(52) U.S. Cl. CPC B60J 7/141

(57) ABSTRACT

A nestable covering assembly for a bed of a truck includes a pair of rails, each of which comprises a plurality of channels. Each rail is mountable to a respective opposed sidewall of a bed of a truck so that the rail extends from proximate to a front of the bed to proximate to a rear of the bed. A plurality of nested panels is slidably engaged to the rails so that each nested panel extends between the rails. Respective nested panels are operationally engaged to associated channels so that the respective nested panels are selectively slidable between a nested configuration and an extended configuration. In the extended configuration, the plurality of nested panels covers the bed of the truck and protects contents of the bed.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### Field of the Invention

The disclosure relates to covering assemblies and more particularly pertains to a new covering assembly for a bed of a truck. The present invention discloses a covering assembly comprising more than two nested panels, which are slidably engaged to rails mounted singly to opposed sidewalls of the bed.

### Description of Related Art Including Information Disclosed Under 37 CFR 1.97 and 1.98

The prior art relates to covering assemblies. Prior art covering assemblies may comprise foldable hinged panels, rollable panels, pairs of telescoping panels, and individual panels that cover sections of beds. What is lacking in the prior art is a covering assembly comprising more than two nested panels, which are slidably engaged to rails mounted singly to opposed sidewalls of the bed.

### BRIEF SUMMARY OF THE INVENTION

An embodiment of the disclosure meets the needs presented above by generally comprising a pair of rails, each of which comprises a plurality of channels. Each rail is configured to be mountable to a respective opposed sidewall of a bed of a truck so that the rail extends from proximate to a front of the bed to proximate to a rear of the bed. A plurality of nested panels is slidably engaged to the rails so that each nested panel extends between the rails. Respective nested panels are operationally engaged to associated channels so that the respective nested panels are selectively slidable between a nested configuration and an extended configuration. In the extended configuration, the plurality of nested panels covers the bed of the truck and is configured to protect contents of the bed.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWINGS

The disclosure will be better understood and objects other than those set forth above will become apparent when consideration is given to the following detailed description thereof. Such description makes reference to the annexed drawings wherein:

FIG. 1 is an isometric perspective view of a nestable covering assembly in a nested configuration according to an embodiment of the disclosure.

FIG. 2 is an isometric perspective view of an embodiment of the disclosure in a partially extended configuration.

FIG. 3 is an isometric perspective view of an embodiment of the disclosure in a fully extended configuration.

FIG. 4 is a top view of an embodiment of the disclosure in the fully extended configuration.

FIG. 5 is a top view of an embodiment of the disclosure in the nested configuration.

FIG. 6 is a front view of an embodiment of the disclosure.

FIG. 7 is a bottom view of an embodiment of the disclosure in the nested configuration.

FIG. 8 is a detail view of an embodiment of the disclosure.

### DETAILED DESCRIPTION OF THE INVENTION

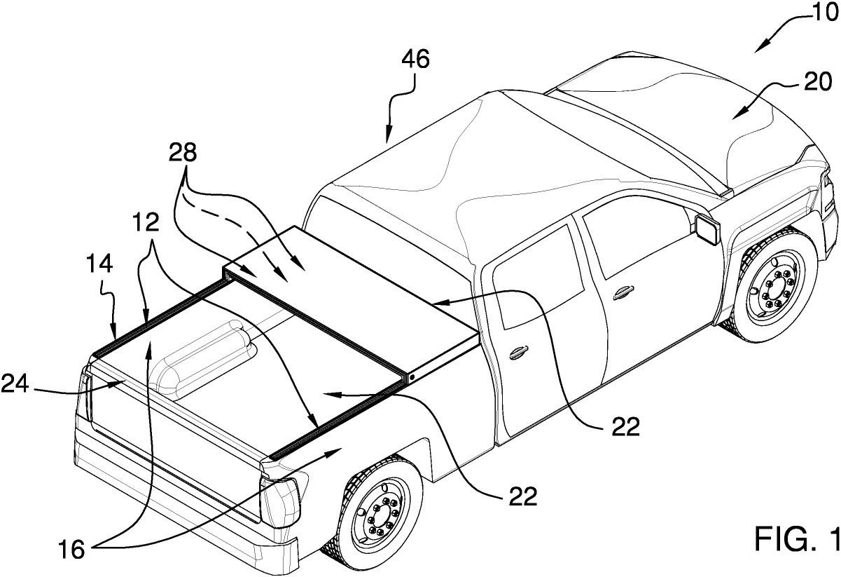

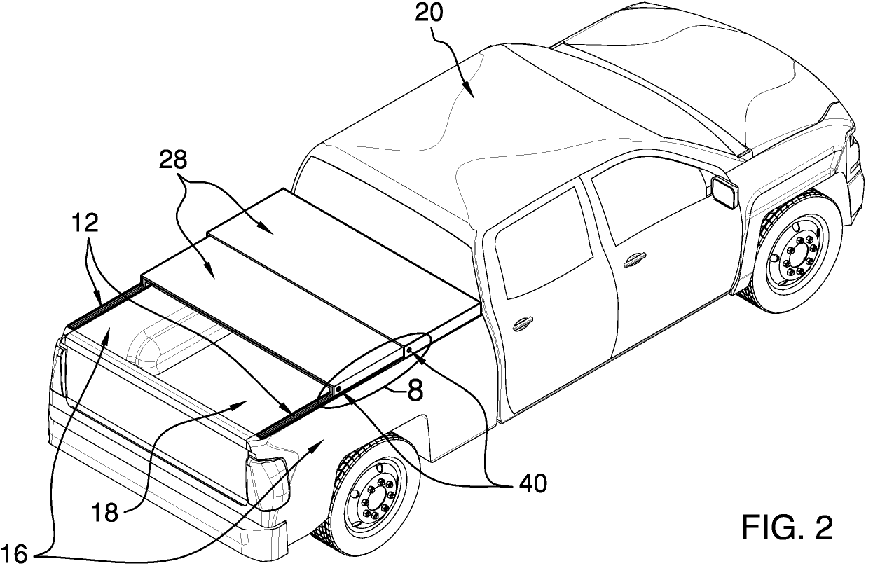

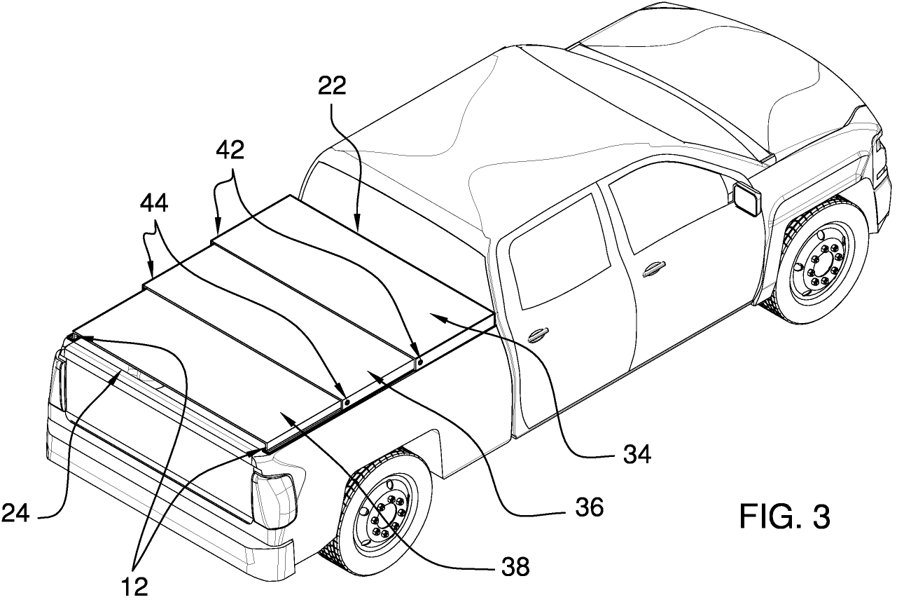

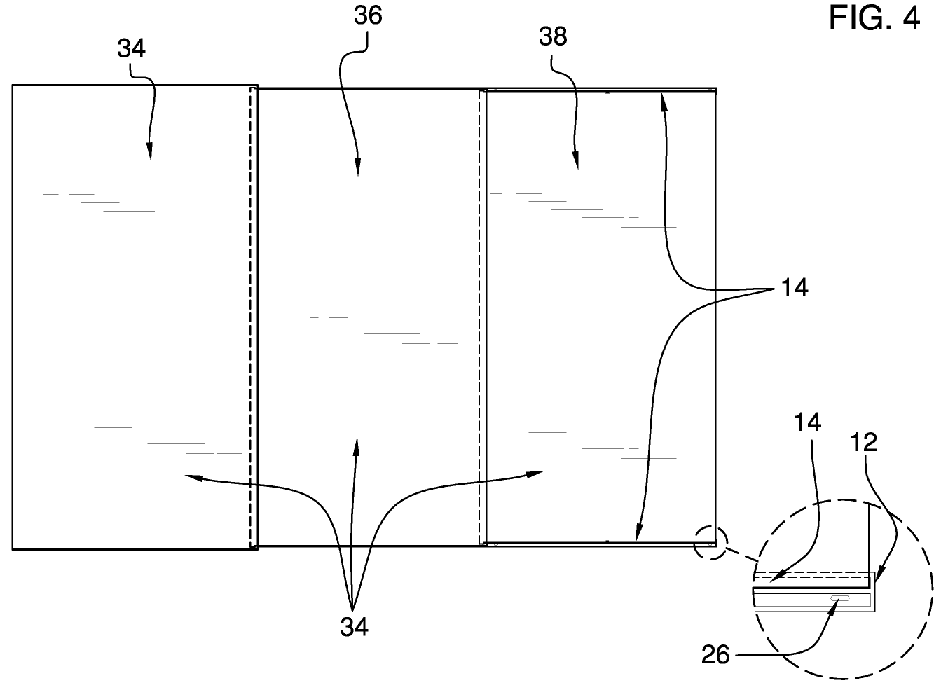

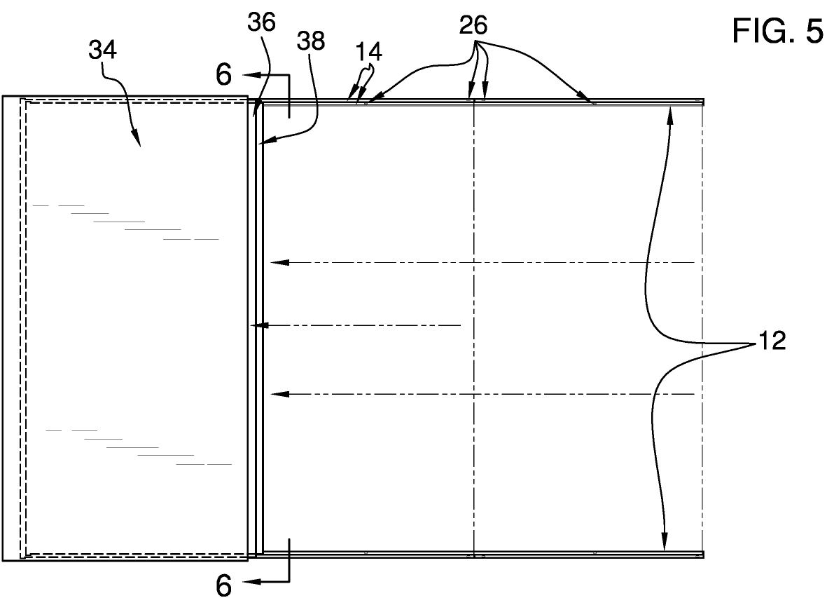

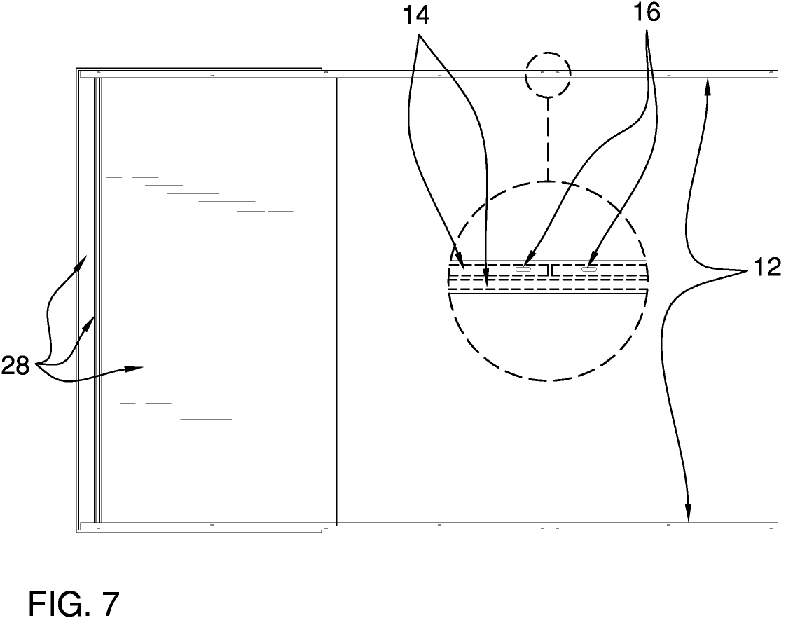

With reference now to the drawings, and in particular to FIGS. 1 through 8 thereof, a new covering assembly embodying the principles and concepts of an embodiment of the disclosure and generally designated by the reference numeral 10 will be described.

As best illustrated in FIGS. 1 through 8, the nestable covering assembly 10 generally comprises a pair of rails 12, each of which comprises a plurality of channels 14. Each rail 12 is configured to be mountable to a respective opposed sidewall 16 of a bed 18 of a truck 20 so that the rail 12 extends from proximate to a front 22 of the bed 18 to proximate to a rear 24 of the bed 18. A plurality of holes 26 is positioned in the pair of rails 12. Each hole 26 is configured for insertion of a respective article of mounting hardware (not shown, but comprising bolts, rivets, and the like) to mount the pair of rails 12 to the opposed sidewalls 16 of the bed 18 of the truck 20.

A plurality of nested panels 28 is slidably engaged to the rails 12 so that each nested panel 28 extends between the rails 12. Respective nested panels 28 are operationally engaged to associated channels 14 so that the respective nested panels 28 are selectively slidable between a nested configuration and an extended configuration. In the extended configuration, the plurality of nested panels 28 covers the bed 18 of the truck 20 and is configured to protect contents of the bed 18. FIGS. 1, 2, and 3, show the plurality of nested panels 28 in nested, partially extended, and fully extended configurations, respectively.

The nested panels 28 comprise fiberglass, aluminum, titanium, or the like. Each nested panel 28 comprises opposed end pieces 30 and a top piece 32, which is engaged to and extends between the opposed end pieces 30. The plurality of nested panels 28 may comprise a forward panel 34, a medial panel 36, and a rearward panel 38, although the present invention anticipates the plurality of nested panels 28 comprising more than three nested panels 28.

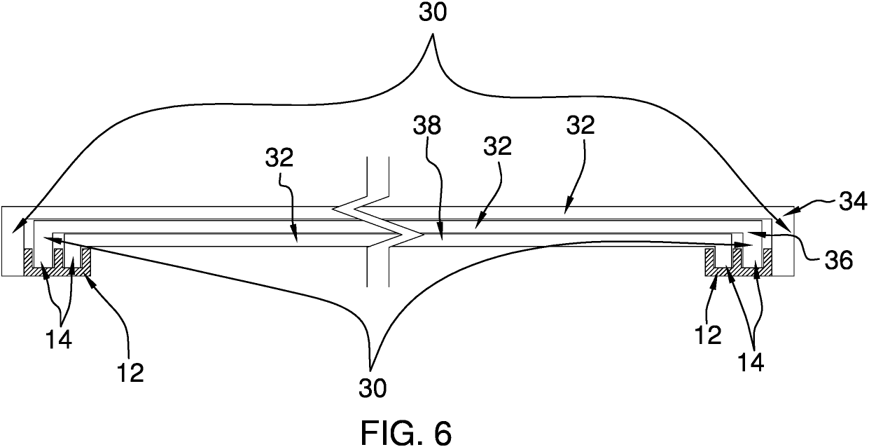

The forward panel 34 is positioned proximate to the front 22 of the bed 18. The opposed end pieces 30 of the forward panel 34 are fixedly engaged to the pair of rails 12. The medial panel 36 is selectively extensible from the forward panel 34. As shown in FIG. 6, the opposed end pieces 30 of the medial panel 36 are dimensionally shorter than the opposed end pieces 30 of the forward panel 34. The rearward panel 38 is selectively extensible from the medial panel 36. As shown in FIG. 6, the opposed end pieces 30 of the rearward panel 38 are dimensionally shorter than the opposed end pieces 30 of the medial panel 36.

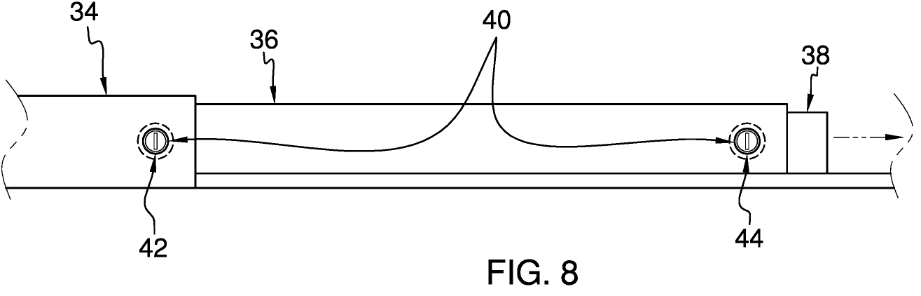

The nested panels 28 may be selectively lockable in the extended configuration. Each of a plurality of locks 40 is engaged to a respective nested panel 28 and is configured to selectively engage an associated nested panel 28 when the associated nested panel 28 is extended from the respective nested panel 28. The locks 40 may be keyed, as shown in FIG. 8. The present invention anticipates other locking means well known to those skilled in the art of locks.

The plurality of locks 40 may comprise a first set 42 of locks 40 and a second set 44 of locks 40. The first set 42 of locks 40 is engaged to the forward panel 34 and is selectively engageable to the medial panel 36 when the medial panel 36 is extended from the forward panel 34. The first set 42 of locks 40 may comprise two locks 40 engaged singly to the opposed end pieces 30 of the forward panel 34. Other configurations of the first set 42 of locks 40 are anticipated, such as, but not limited to, the first set 42 of locks 40 comprising one lock 40, which is engaged to the opposed end piece 30 of the forward panel 34 on a driver’s side 46 of the truck 20, or to the top piece 32 of the forward panel 34 proximate to the driver’s side 46 of the truck 20.

The second set 44 of locks 40 is engaged to the medial panel 36 and is selectively engageable to the rearward panel 38 when the rearward panel 38 is extended from the medial panel 36. The second set 44 of locks 40 may comprise two locks 40 engaged singly to the opposed end pieces 30 of medial panel 36. Other configurations of the second set 44 of locks 40 are anticipated, such as, but not limited to, the second set 44 of locks 40 comprising one lock 40, which is engaged to the opposed end piece 30 of the medial panel 36 on the driver’s side 46 of the truck 20, or to the top piece 32 of the medial panel 36 proximate to the driver’s side 46 of the truck 20.

The nestable covering assembly 10 also may comprise a plurality of gaskets (not shown), which are engaged to the nested panels 28 and which substantially seal the plurality of nested panels 28 when in the extended configuration.

The nestable covering assembly 10 also may comprise a plurality of ball bearing rollers (not shown) positioned in the channels 14 to facilitate sliding of the nested panels 28 along the channels 14. The present invention anticipates the channels 14 being C-channel 14 shaped (not shown), with the opposed end pieces 30 being shaped complementarily so that the opposed end pieces 30 are slidable within the channel 14 without the nested panels 28 being liftable from the rails 12.

In use, the rails 12 are secured to the opposed sidewalls 16 of a bed 18 of a truck 20, with the plurality of nested panels 28 extending between the rails 12. The nested panels 28 can be selectively extended to cover a load in the bed 18 of the truck 20, thereby protecting the load from rain, snow, and the like. The locks 40 can be used to secure the nested panels 28 in the extended configuration to protect the load from theft, vandalism, and the like.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A nestable covering assembly comprising:
a pair of rails, each rail comprising a plurality of channels, each rail being configured to be mountable to a respective opposed sidewall of a bed of a truck, such that the rail extends from proximate to a front of the bed to proximate to a rear of the bed; and
a plurality of nested panels slidably engaged to the rails, such that each nested panel extends between the rails, respective nested panels being operationally engaged to associated channels, such that the respective nested panels are selectively slidable from a nested configuration to an extended configuration, wherein the plurality of nested panels covers the bed of the truck, wherein the plurality of nested panels is configured for protecting contents of the bed.

2. The nestable covering assembly of claim 1, further including a plurality of holes positioned in the pair of rails, wherein each hole is configured for insertion of a respective article of mounting hardware for mounting the pair of rails to the opposed sidewalls of the bed of the truck.

3. The nestable covering assembly of claim 1, wherein the nested panels are selectively lockable in the extended configuration.

4. The nestable covering assembly of claim 1, wherein the nested panels comprise fiberglass, aluminum, or titanium.

5. The nestable covering assembly of claim 1, wherein each nested panel comprises:
opposed end pieces; and
a top piece engaged to and extending between the opposed end pieces.

6. The nestable covering assembly of claim 5, wherein the plurality of nested panels comprises:
a forward panel positioned proximate to the front of the bed;
a medial panel selectively extensible from the forward panel; and a rearward panel selectively extensible from the medial panel.

7. The nestable covering assembly of claim 6, wherein:
the opposed end pieces of the forward panel being fixedly engaged to the pair of rails;
the opposed end pieces of the medial panel being dimensionally shorter than the opposed end pieces of the forward panel; and
the opposed end pieces of the rearward panel being dimensionally shorter than the opposed end pieces of the medial panel.

8. The nestable covering assembly of claim 3, further including a plurality of locks, each lock being engaged to a respective nested panel and being configured for selectively engaging an associated nested panel when the associated nested panel is extended from the respective nested panel.

9. The nestable covering assembly of claim 8, wherein the locks are keyed.

10. The nestable covering assembly of claim 7, further including a plurality of locks comprising:
a first set of locks engaged to the forward panel and being selectively engageable to the medial panel when the medial panel is extended from the forward panel; and
a second set of locks engaged to the medial panel and being selectively engageable to the rearward panel when the rearward panel is extended from the medial panel.

11. The nestable covering assembly of claim 10, wherein the locks are keyed.

12. The nestable covering assembly of claim 10, wherein:
the first set of locks comprising two locks engaged singly to the opposed end pieces of forward panel; and
the second set of locks comprising two locks engaged singly to the opposed end pieces of medial panel.

13. A nestable covering system comprising:
a truck having a bed defined by opposed sidewalls;
a pair of rails, each rail comprising a plurality of channels, each rail being mounted to a respective opposed sidewall, such that the rail extends from proximate to a front of the bed to proximate to a rear of the bed; and
a plurality of nested panels slidably engaged to the rails, such that each nested panel extends between the rails, respective nested panels being operationally engaged to associated channels, such that the respective nested panels are selectively slidable from a nested configuration to an extended configuration, wherein the plurality of nested panels covers the bed of the truck, wherein the plurality of nested panels is configured for protecting contents of the bed.

14. The nestable covering system of claim 13, wherein the nested panels comprise fiberglass, aluminum, or titanium.

15. The nestable covering system of claim 13, wherein:
each nested panel comprises:
opposed end pieces, and
a top piece engaged to and extending between the opposed end pieces; and
wherein the plurality of nested panels comprises:
a forward panel positioned proximate to the front of the bed, the opposed end pieces of the forward panel being fixedly engaged to the pair of rails,
a medial panel selectively extensible from the forward panel, the opposed end pieces of the medial panel being dimensionally shorter than the opposed end pieces of the forward panel, and
a rearward panel selectively extensible from the medial panel, the opposed end pieces of the rearward panel being dimensionally shorter than the opposed end pieces of the medial panel.

16. The nestable covering system of claim 15, further including a plurality of locks comprising:
a first set of locks engaged to the forward panel and being selectively engageable to the medial panel when the medial panel is extended from the forward panel; and
a second set of locks engaged to the medial panel and being selectively engageable to the rearward panel when the rearward panel is extended from the medial panel.

17. The nestable covering system of claim 16, wherein the locks are keyed.

18. The nestable covering system of claim 16, wherein:
the first set of locks comprising two locks engaged singly to the opposed end pieces of forward panel; and
the second set of locks comprising two locks engaged singly to the opposed end pieces of medial panel.

19. A nestable covering assembly comprising:
a pair of rails, each rail comprising a plurality of channels, each rail being configured to be mountable to a respective opposed sidewall of a bed of a truck, such that the rail extends from proximate to a front of the bed to proximate to a rear of the bed;
a plurality of holes positioned in the pair of rails, wherein each hole is configured for insertion of a respective article of mounting hardware for mounting the pair of rails to the opposed sidewalls of the bed of the truck;
a plurality of nested panels slidably engaged to the rails, such that each nested panel extends between the rails, respective nested panels being operationally engaged to associated channels, such that the respective nested panels are selectively slidable from a nested configuration to an extended configuration, wherein the plurality of nested panels covers the bed of the truck, wherein the plurality of nested panels is configured for protecting contents of the bed, the nested panels being selectively lockable in the extended configuration, the nested panels comprising fiberglass, aluminum, or titanium, each nested panel comprising:
opposed end pieces, and
a top piece engaged to and extending between the opposed end pieces;
the plurality of nested panels comprising:
a forward panel positioned proximate to the front of the bed, the opposed end pieces of the forward panel being fixedly engaged to the pair of rails,
a medial panel selectively extensible from the forward panel, the opposed end pieces of the medial panel being dimensionally shorter than the opposed end pieces of the forward panel, and
a rearward panel selectively extensible from the medial panel, the opposed end pieces of the rearward panel being dimensionally shorter than the opposed end pieces of the medial panel; and
a plurality of locks, each lock being engaged to a respective nested panel and being configured for selectively engaging an associated nested panel when the associated nested panel is extended from the respective nested panel, the locks being keyed, the plurality of locks comprising:
a first set of locks engaged to the forward panel and being selectively engageable to the medial panel when the medial panel is extended from the forward panel, the first set of locks comprising two locks engaged singly to the opposed end pieces of forward panel, and
a second set of locks engaged to the medial panel and being selectively engageable to the rearward panel when the rearward panel is extended from the medial panel, the second set of locks comprising two locks engaged singly to the opposed end pieces of medial panel.
